(19) United States
(12) Patent Application Publication
(10) Pub. No.: US 2008/0054501 A1
(43) Pub. Date: Mar. 6, 2008

(54) Cyclonic air fuel mixture plate

(76) Inventor: Paul H. Counts, Haysville, KS (US)

Correspondence Address: RUTH EURE, 4795 EDISON AVENUE, BOULDER, CO, 80301, US

(21) Appl. No.: 11/649,462

(22) Filed: Jan. 3, 2007

Related U.S. Application Data
(60) Provisional application No. 60/842,392, filed on Sep. 5, 2006.

(51) Int. Cl. F02M 29/06; C10J 1/08; F02M 17/20

(52) U.S. Cl. 261/79.1; 261/DIG. 55

(57) ABSTRACT

This invention relates to an internal combustion engine and in particular to a method of improving the air and fuel mixture while in the engine's cylinder. This method involves generating a reversible cyclone effect, as the air and fuel mixture moves up and down the cylinder, during the engine's four cycles. The present invention consists of a plate that is seated between 2 head gaskets. The plate's purpose is to position angled vanes within the engine cylinder's cavity. These vanes are intended to direct the air-fuel mixture into a cyclonic flow, thereby enhancing the uniformity of the mixture. This is anticipated to improve the overall efficiency of the engine, improving gas mileage and reducing the catalytic converter's need or capacity.

### CLAIM OF PRIORITY

This patent application claims priority from U.S. Provisional Patent Application Ser. No. 60/842,392 filed Sep. 5, 2006

### FIELD OF INVENTION

This invention relates to the field of internal combustion engines, and more specifically to air-fuel mixing methods for internal combustion engines.

### BACKGROUND OF THE INVENTION

This invention relates to an internal combustion engine and in particular to a method of improving the air and fuel mixture while in the engine's cylinder. This method involves generating a reversible cyclone effect, as the air and fuel mixture moves up and down the cylinder, during the engine's four cycles. Traditional engines mix the fuel with the air, using the inherent flow of the air and fuel during the 4 cycles as well as through valve timing.

Some existing inventions include that described in U.S. Pat. No. 4,672,940 to Nakayama et al, for example. This reference describes a honeycomb flow control structure for creating turbulent air flow. It appears that this honeycomb is placed in the intake passage.

U.S. Pat. No. 5,829,408, to Yamaguchi et al, describes an apparatus for mixing the air and fuel to create a swirl or vortex motion in the cylinder. It appears that this includes two directional channels in the main air intake passage. These channels direct the air so as to enter one side of the intake valves, while the fuel injection system, directs the fuel to the other side of the valves.

U.S. Pat. No. 5,850,816, to Ohsuga et al also describes an apparatus that creates a swirl in the air through the use of directional air control, also positioned in the air intake passage. These directors appear to consist of an air control valve and two moveable channels that direct the air towards certain sections of the valves.

U.S. Pat. No. 7,055,513 to Boveia describes a spacer plate, placed in the air intake path to improve engine performance. It appears that there are air director features cut into the circumferential cross section of the plate's air passage, so as to create a specific air flow.

U.S. Pat. No. 6,158,412 to Kim et al describes a turbulence generator that can be placed in the air intake or exhaust passages. This device uses curved angled vanes to generate swirling air.

None of the above cited references put forth a simple directional plate with vanes, placed in between the head gaskets that create a reversible cyclonic motion in the cylinder itself.

### SUMMARY OF THE INVENTION

The present invention consists of a plate that is seated between 2 head gaskets. The plate's purpose is to position angled vanes within the engine cylinder's cavity. These vanes are intended to direct the air-fuel mixture into a cyclonic flow, thereby enhancing the uniformity of the mixture. This is anticipated to improve the overall efficiency of the engine, improving gas mileage and reducing the catalytic converter's need or capacity.

It consists of at least one plate, with at least one slot or passage way so as to allow the air-fuel mixture to flow freely throughout the cylinder. Vanes protrude away from the plate in a direction and angle that created this cyclonic motion. The cyclone's flow is reversible so as to continuously improve the mixtures consistency and thereby the uniformity of combustion. During the intake cycle, the mixture will flow downwards through the slots, and during the compression cycle, it will be compressed upwards through the slots, reversing the flow direction. During the combustion cycle, the mixture will move downwards once more, reversing direction for the second time. Finally the mixture will reverse direction once more as it exits the cylinder during the exhaust cycle.

This plate can consist of a multitude of slots and vane patterns that match that of the cylinder configurations, for example a four cylinder in line configuration.

### BRIEF DESCRIPTION OF THE DRAWINGS

FIGS. 1a, 1b and 1c show three embodiments of the slots and vane patterns on the cyclonic plate.

FIGS. 2a and 2b show two cross sectional embodiments of the plate.

FIG. 3 is a schematic diagram showing the detail of the placement of the plate in the cylinder.

FIG. 4 is a schematic diagram showing a plate configured for a four cylinder in-line flat configuration.

### DETAILED DESCRIPTION

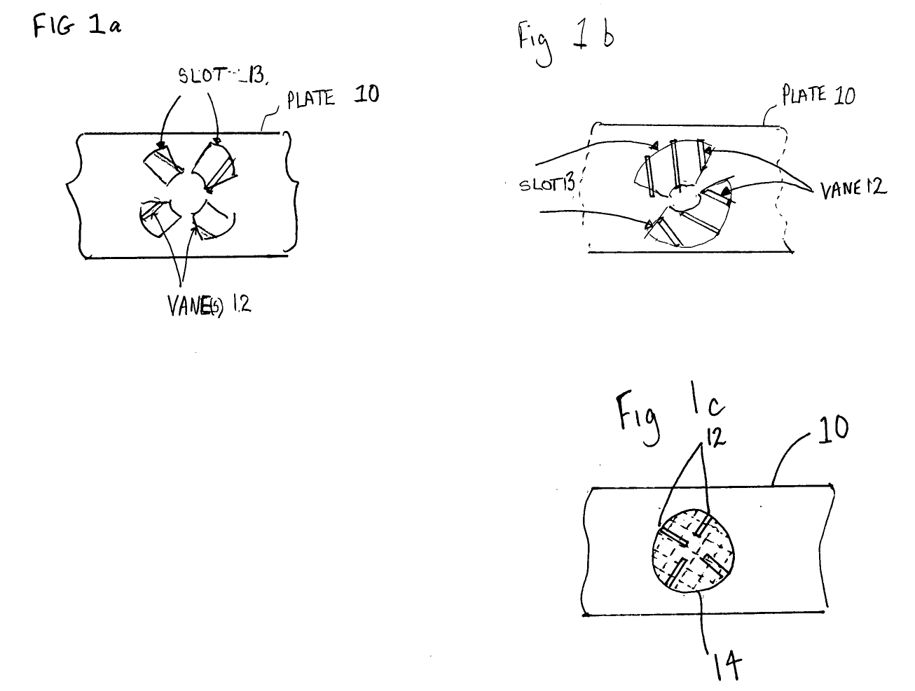

Please refer to FIG. 1. FIGS. 1a, 1b and 1c show three embodiments of the cyclonic air-fuel mixture plate. The invention essentially consists of a thin plate 10, at least one slot 13 and at least one vane 12, that protrude(s) away from the plate 10. The plate 10 is intended to lie between two head gaskets 7. The vane 12 may be coated with catalyst, similar to a catalytic converter coating. Suitable catalysts include silica and alumina, for example.

FIG. 1a shows a plate 10 with four slots 13 to allow the air-fuel mixture to pass through the plate 10. This mixture can pass through the slots 13 in both directions during the engine's four cycles. The slots 13 are shaped so as to follow the shape of the engine's cylinder 1 and may be at least half an inch wide. Vanes 12 are positioned across the slots 13 to direct the air and fuel to move in a cyclonic direction. The vanes 12 may be about four and a half inches square and may be angled at a 45 degree angle to the plate 10.

FIG. 1b shows a plate 10 with two slots 13 and a multitude of vanes 12 protruding away from the plate 10.

FIG. 1c shows a plate 10 with one circular slot 13 which has a grid 14 on it. This grid 14 supports the vane(s) 12 but minimizes air and fuel flow restriction.

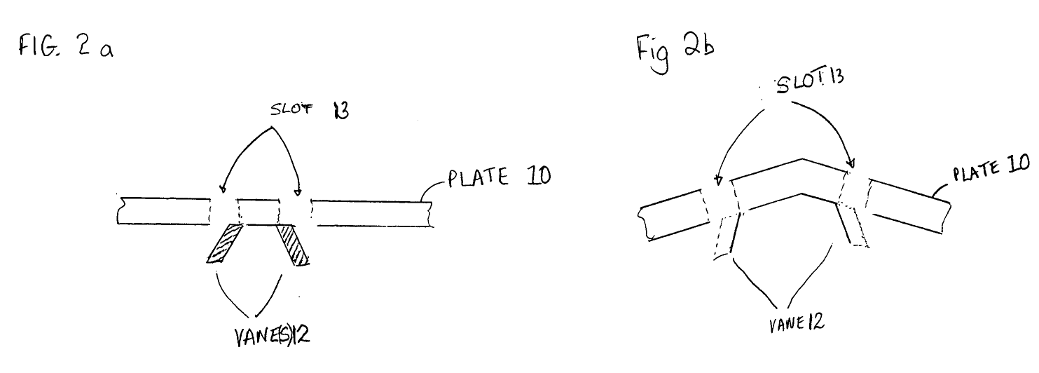

FIG. 2 shows two embodiments of the plate's 10 configuration. FIG. 2a shows a flat plate 10 with two slots 13 and two vanes 12. FIG. 2b shows an angled plate 10, so as to mate with other potential engine piston shapes.

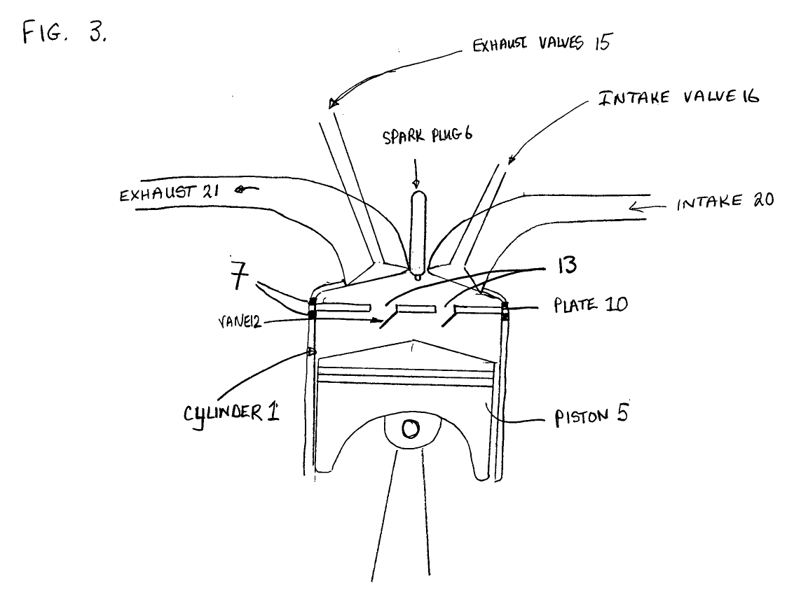

FIG. 3 shows a cross section of an engine piston 5 and cylinder 1 and how this plate 10 is to be placed. On the intake stroke, air and fuel will enter the cylinder 1 though the intake 20 and open intake valve 16. It will enter the cylinder 1 and be directed into a cyclonic motion by the vane(s) 12 as it moves through the slot(s) 13. As the cylinder 1 moves upwards during the compression stroke, the air and fuel will be pushed upwards towards the spark plug 6 and directed in the opposition cyclonic direction by the vane(s) 12. During the combustion stroke as the air and fuel travel back down the cylinder 1 and through the slot(s) 13 once more, the motion of the air and fuel mixture will be reversed. Finally during the exhaust stroke, the exhaust valve 21 will open and the mixture's motion will be reversed once more by the vane(s) 12, as it travels upward in the cylinder 1 and exits through the exhaust 21.

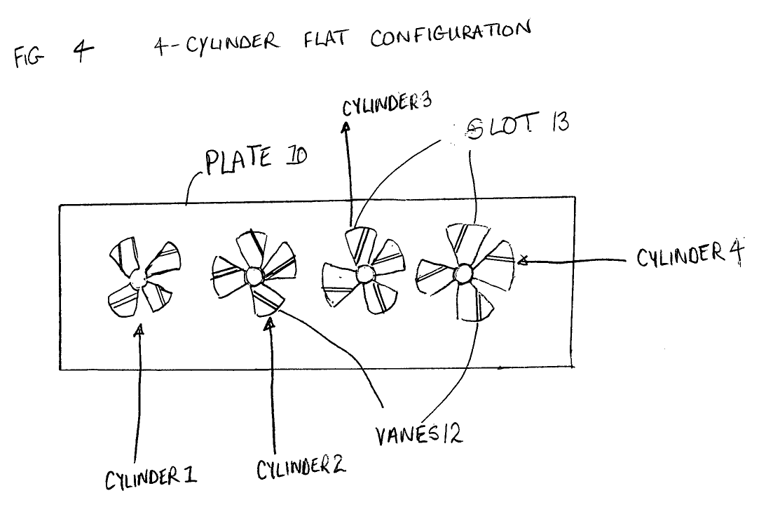

FIG. 4 shows a potential configuration for the plate for a four cylinder in-line engine. The plate 10 consists of four repeated sections that are intended to line up with the each of four cylinders 1, 2, 3 and 4.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

What is claimed is:

1. A cyclonic air-fuel mixture plate for placement between two head gaskets comprising:
a plate having two parallel surfaces;
at least one centrally located slot in the plate, for air and fuel to pass through;
at least one vane attached to and protruding from one of the plate's surfaces so that the air and fuel are redirected into a cyclonic flow.

2. A cyclonic air-fuel mixture plate as in claim 1 with repeated slot and vane patterns according to the engine's cylinder pattern.

3. A cyclonic air-fuel mixture plate as in claim 1 where the plate is angled to match the cylinder shape.

4. A cyclonic air-fuel mixture plate as in claim 1 where the slot is covered with a grid.

5. A cyclonic air-fuel mixture plate as in claim 1 where the vanes are approx square and four an a half inches by four and a half inches in length and width.

6. A cyclonic air-fuel mixture plate as in claim 1 where the slots are approximately half and inch wide.

7. A cyclonic air-fuel mixture plate as in claim 1 where the vanes are coated with catalyst.
